(19) United States
(12) Patent Application Publication
(10) Pub. No.: US 2026/0195611 A1
(43) Pub. Date: Jul. 9, 2026

(54) A SELF-ADAPTIVE FAULT CORRELATION SYSTEM BASED ON CAUSALITY MATRICES AND MACHINE LEARNING

(71) Applicant: ALTICE LABS, S.A, Aveiro (PT)

(72) Inventors: Pedro Jorge RITO LIMA, Aveiro (PT); Carlos Guilherme VARELA ARAÚJO, Aveiro (PT)

(21) Appl. No.: 19/130,739

(22) PCT Filed: Nov. 16, 2023
(86) PCT No.: PCT/EP2023/025486

§ 371 Date: May 16, 2025

(30) Foreign Application Priority Data
Nov. 16, 2022 (PT) 118348

(51) Int. Cl. G06N 5/01; G06F 18/10; G06F 123/02

(52) U.S. Cl. CPC G06N 5/01; G06F 18/10; G06F 2123/02

(57) ABSTRACT

The present invention describes a self-adaptive system capable of extracting correlations between multiple faults from net-work topologies, with the innovative component being the data preprocessing phase generating causality matrices to provide as an input to ML models. The proposed fault correlation system is responsible for, without any configuration, identifying the hierarchical relationships be-tween the multiple alarms, allowing for a better understanding of the causality and impact of each malfunction, hence assisting the implementation of RCA rules. This allows, not only for a huge dimensionality reduction of alarms needed to be processed by a TO's, but also significantly increases the knowledge about the topology, thus reducing downtime and increasing the quality of service of the network and services.

### FIELD OF THE INVENTION

The present invention is enclosed within the field of pattern recognition in the context of Root Cause Analysis (RCA) for fault management. Particularly, the present invention relates to a method of applying Machine Learning (ML) techniques to topology alarm events, for detecting the underlying correlations and assist the RCA rule creation process.

### PRIOR ART

Telecommunication networks are increasingly complex, with more devices connected and, consequently, subject to more failures, thus generating enormous amounts of alarm events. Moreover, as most of the connected nodes of the network are essential to its proper function, all alarms need to be processed to better understand the underlying problem and its correction, so that the anomalous device can proceed with its functions.

Root Cause Analysis (RCA) tools have emerged intending to identify correlations between problems and their underlying cause. These tools need a set of predefined rules (based on human knowledge) to do the RCA, thus creating a hierarchical relationship between failures. The increasing complexity in patterns and information volume results in larger and more complex problems. These problems became near impossible for humans to be able to deal with, opening roads to Machine Learning (ML) which thrives on the dimensionality of the problem under analysis. Either in scenarios H success (fault correction) or failure (the fault remains active or was forcibly terminated), alarm instances are produced. This implies that throughout the continuous operation time, a vast amount of data is processed and stored, however, it is unusable as the patterns are undetectable to the human eye and brain. ML, on the other hand, is capable of processing big data, training models able to extract helpful information from the fault history, fostering problems'understanding, correlation, and resolution. Furthermore, promptly solving the problems that arise is crucial to satisfy the Service Level Agreements (SLAs) established with customers, bringing competitive advantages to Telecommunication Operators (TOs).

### PROBLEM TO BE SOLVED

RCA tools are becoming increasingly vital to maintain the efficient and seamless support of networks. However, the manual definition of RCA rules is becoming more and more complex. Not only the increased complexity of telecommunication networks generates more failures and alarm events, but it also makes it nearly impossible to manually fix them. This creates a problem that needs to be solved to maintain the correct functioning of all technical equipment managed by TOs. Combining RCA tools with ML techniques, capable of detecting patterns in huge amounts of data, which would be near impossible from a human perspective, is therefore imperative.

The extrapolation of the relationships and hierarchies among different types of alarms allows understanding the impact of a failure on the entire system, thus easing, and supporting system administrators in the creation of proper and previously unknown RCA rules.

### SUMMARY OF THE INVENTION

The self-adaptive fault correlation system comprises a method for managing predicting abnormalities of a communications network, which is subdivided into three components: (i) the pre-processing applied to the alarm events thus generating the causality matrix; (ii) the ML models training and explainability which allows extracting the newly discovered correlations ; (iii) the Application Programming Interface (API) capable of providing services and operations upon them.

The causality matrix creation for the training phase is the core component on which the patent is being developed. The main innovative factor of this approach is related to the pre-processing of data and the information provided to the ML models. Although the data provided by the TO consists of millions of alarm instances, where each one is composed of a myriad of attributes, among which it is worth highlighting the equipment at fault, the location where the failure occurred, the specific problem detected, the equipment manufacturer and the technology in use, this content is not directly provided to the models. The combination of the three latter attributes, representing a trio, is the approach's core entity used as a predictor. The innovative pre-processing phase, upon receiving these trios, creates 10 causality matrix which is the data provided to the ML models. Each matrix is composed of multiple sliding windows, each one representing the quantification of alarm types of occurrences (trios), prior to the capture of a specific alarm instance, and the target variable represents whether such instance occurred. Thus, the causality matrix will have as many entries as the number of alarm instances provided by the TO, while the number of columns will vary depending on the number of predictors detected across the alarm dataset.

Once the causality matrix has been generated, it is possible to create and train the ML models. Since the columns represent the trios in the dataset, the number of predictors is varies between models and is, in general, extremely high. Thus, the algorithm used is Random Forest (RF), which is not only able to properly handle the number of features variability, but also shines in the presence of multiple predictors, where on their own they have little weight, but collectively have a lot. As aforementioned, the ML models have no access to the alarms'attributes, having only the causality history between them, forcing them to detect correlations among alarms, as this is the only information they have been given. It is also worth highlighting that, contrary to the most common practice of training ML models for its later prediction stage, in this approach, the information being predicted is known a priori. The purpose is instead to extract the knowledge and the process used by the model to successfully perform its prediction task—extraction of the detected correlations.

The self-adaptive fault correlation system further comprises a framework developed to integrate this innovation, whose purpose is to link multiple crucial components together, allowing the real-time evaluation of correlations and patterns across alarms. Initially, the framework is responsible for consuming the real-time alarms generated by the TO, which are a continuous stream of data, and if the requirements needed for analysis are satisfied since not all alarms are used, as they have different types and purposes-they are stored into a database, thus being persistently saved for future processing. This framework is also responsible for detecting the necessary conditions for training, which may or may not be executed on the same instance, as the framework was developed for a distributed operation, such as a computer cluster.

Finally, and as aforementioned, the objective of the training process is not to predict alarms, but to extract the knowledge developed for prediction. The self-adaptive fault correlation system further includes an API, which comprises adapted for: (i) the extraction of the knowledge regarding any alarm class already trained; (ii) the denial of causality between two different classes allowing the introduction of theoretical and/or empirical knowledge about the system, thus avoiding the detection of false correlations. This has proved necessary since no information is given to the model, so it is detecting correlations between the entire sample universe, which can lead to a Post Hoc, Ergo Propter Hoc scenario; (iii) the reactivation of a previously denied correlation, both in case it was erroneously made or if the topology has changed and the knowledge provided about the system needs to be updated.

In sum, the invention hereby described comprises the alarm data pre-processing approach, the ML models training and correlation extraction and the enveloping framework for its operationalization. Advantageously, the invention represents the artificial intelligence component to be added to the alarmistic sector, thus complementing the current tool used for alarm management and assisting the extrapolation of knowledge for the implementation of RCA rules.

### DESCRIPTION OF FIGURES

FIG. 1A is a tabular representation of the application of the pre-processing developed in the invention to a default TO's dataset aggregating by unique problem per model.

FIG. 1B demonstrates the application of the same technique but aggregating for each unique trio.

FIG. 2 is a diagram of the architecture of the entire pattern recognition system in a cluster execution scenario.

FIG. 3 is a flowchart demonstrating the behavior of a topology alarm consumption and how it can trigger a training phase.

FIG. 4A-4C is a set of sequence diagrams demonstrating the behavior of the multiple components to respond to the four main endpoints of the system.

### DETAILED DESCRIPTION

The present disclosure relates to an innovation capable of detecting correlations among multiple alarms from a TO, detecting their impact on the entire system, and assisting the RCA rules implementation by providing new system information. This is a necessity due to the current dimensionality of TO topologies, which makes it nearly impossible to define manual rules and all causality hierarchies. As aforementioned, the invention comprises 3 main components: (i) the unique data pre-processing applied to create causality matrixes which will be provided to the ML models for the training phase, thus minimizing the entropy of TOs data, and maximizing correlation detection. This is the core component, as it represents the most innovative factor that allowed the creation of training data capable of guiding the learning process of the models through root-cause discovery; (ii) the ML models creation for each causality matrix, thus generating a model per unique trio, responsible for identifying its root cause. Optionally, further embodiments of the invention include the application of features importance allows extracting unknown correlations, acting as Explainable Artificial Intelligence (XAI) ; (iii) a complete Application Programming Interface (API) encompassing all tool's components, to enable the operationalization and commercialization of the innovative approach, thus providing multiple services and operations.

Regarding the pre-processing phase, one of the properties to highlight is the discarding of almost all the default information and the application of the Cartesian product on the most relevant features, thus generating a new dataset. While initially on each alarm instance there are numerous information and variables, most of them are irrelevant for the tool's purpose—to detect correlations among alarms—so they are not considered. Consequently, the preferred embodiment of the present invention considers only four features at each instance: the specific problem that occurred, the faulty equipment manufacturer, the technology it uses, and the location where the failure occurred. However, these 4 attributes alone are not directly useful for correlation detection, so two innovative aspects of the approach arise: (i) generation of a new dataset by applying a Cartesian product between the three most relevant predictors and separating them by their spatial aggregation, thus creating the new core entity—trio; (ii) the ML models'prediction task is a previously known information—the occurrence or not of a certain trio after a time window of alarms—forcing them to detect correlations to successfully predict it. Therefore, the entire training phase will not aim at improving the ML models for the prediction stage, but rather to refine them for further extraction of the developed knowledge for its successful prediction.

In more detail, for each alarm, the four previously mentioned attributes are stored and are temporally ordered until the causality matrix creation requirements for a specific trio are met, where: (i) all the existing combinations of those three predictors are calculated via Cartesian product; (ii) these combinations become the predictors of the dataset; (iii) for each alarm, all entries that occurred in the last five minutes are verified and accounted for in their respective column, thus generating a causality time window. This represents, for each processed alarm, all SpecificProblem×Manufacturer×Technology combinations detected in the prior moments; iv) iteratively applying to all entries, generates a dataset with the same number of entries as alarms, where each one represents the temporal window of the alarm, instead of its attributes, which is considerably more relevant information for a causality detection task.

Having a trio causality matrix generated, which is the actual data that the model has available to learn upon, preferably, a Random Forest (RF) is created for its respective trio. This ML algorithm is used for the following reasons: i) the number of features varies between trios as the predictors detected in their sliding windows may be different. RF can deal with this variability and succeed with many or few predictors; ii) each predictor alone represents initially little predictive power, but collectively represent a lot, which is ideal for RF; iii) is an ensemble algorithm, consisting of multiple decision trees, thus making the prediction much more accurate and weighted. Each RF trains upon the causality matrix of its respective trio, detecting if, after each sliding window analysis, its trio will occur. The ML model's predicted feature is known a priori, forcing the model to discover all the alarms'correlations and hierarchies to successfully perform its prediction task, being this the core innovation factor that transforms an unsupervised problem into a supervised one. Through feature importance, which is a global explainer within XAI, it is possible to extract from the models and to provide to the TOs previously unknown correlations, enabling and accelerating the whole RCA rule creation process.

The invention further comprises an API which is the component that allows all the operationalization of the application of ML techniques and encapsulates all the components and technologies used in the tool. It should also be noted that: (i) it was fully developed with performance and scalability concerns, as it will not only absorb enormous amounts of data but also processes it for a respective training phase. Therefore, it is also structured so an embodiment can be executed in a cluster environment, dividing the heavy load among the numerous instances available, significantly reducing the processing time and thus allowing real-time correlation detection; (ii) the system is self-adaptive, in the sense that it requires neither any pre-configuration for its correct operation nor any information about the topology on which it will operate. It can thus be characterized as “Plug and Play” (PnP), as from the moment it is started, it will consume alarm events and start identifying correlations. From a macro perspective, this API is responsible for aggregating the following components: (i) connection to the TO stream-processing platform responsible for controlling all topology events and alarm events, thus consuming in real-time all events detected in the network; (ii) database storage so that the alarm events are stored persistently for a subsequent training phase; (iii) automation of the training phase when the necessary conditions are met and application of the innovative data pre-processing phase; (iv) multiple endpoints related to the ML models, thus allowing their operationalization and use in a real-world context.

As fault events are streaming in real-time, multiple individual inputs need to be processed until the conditions for training are achieved. Thus, it was necessary to develop a component capable of singularly processing them, identifying which instances should be stored (as not all alarms have useful information for a correlation detection context). Such is the API's responsibility, which, using parallel computing mechanisms, can consume thousands of events per second, ensuring the proper processing without creating any bottleneck for the tool.

In such preferred embodiment, the referred framework works in real-time, that is, it is non-stop running and capturing alarms from the environment to identify correlations. However, in an area like ML, where the size of the dataset is extremely relevant, as an ML model is only as good as the data it was given to learn upon, it was necessary to create an aggregation mechanism. This was persistent database storage, which allows the API to freely consume the streaming alarm events and store them until the conditions required for training have been verified. Regarding the conditions required for training, these take into consideration not only the minimum number of total alarm inputs needed but also the number of each trio itself, thus avoiding class imbalance issues.

Finally, multiple endpoints were made available to provide functionality over the ML models. These allow the extraction of the knowledge inferred by the models during their training phase by identifying multiple correlations. As no a priori knowledge is introduced to the system, there is the possibility of a Post Hoc, Ergo Propter Hoc scenario, so the functionalities of denying a correlation are also made available, thus allowing the introduction of theoretical knowledge into the system.

### DESCRIPTION OF THE EMBODIMENTS

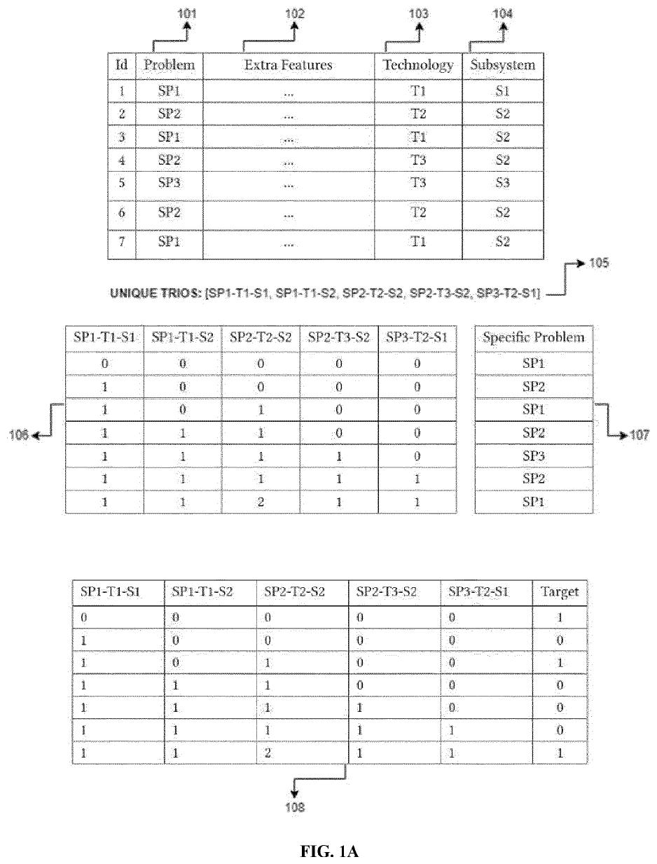

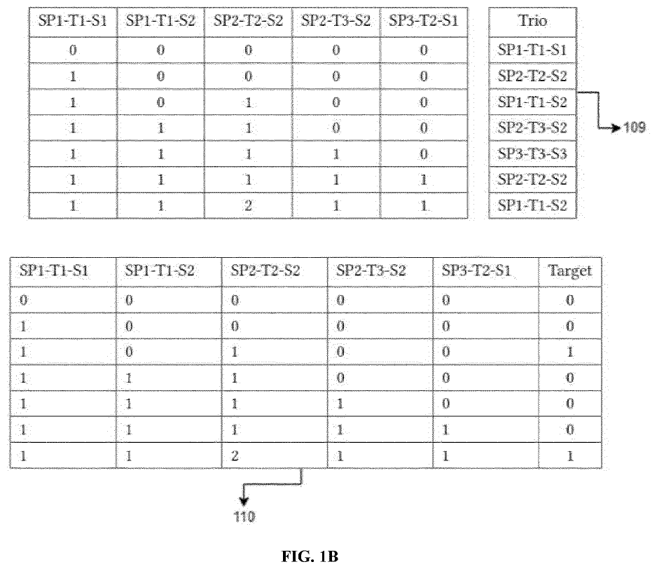

FIG. 1A is a tabular representation of the pre-processing applied to the default dataset to generate a model's causality matrix. By principle, the root problem must happen before its consequences, this implies there is a time causality property to the problem, such will be exploited in this approach, so the system 100 is the temporally organized concatenation of several alarms detected in the TO's topology. Additionally, as aforementioned, an alarm is composed of multiple fields, however almost all that data is disregarded for the implementation of this technique as the purpose is to understand which alarms trigger others based merely on their occurrence and history. Thereby, a new type of event is created and, henceforth, an alarm is represented by the following triple: (specific problem detected in the equipment 101, the technology that equipment uses 103, the manufacturer of the equipment 104), all the alarm remaining features 104 can be discarded as they serve no purpose for the challenge at hand.

Once the dataset has been temporally sorted and the unnecessary columns removed, it is possible to proceed to the calculation of all trios, since these are the new predictors of the system, thus obtaining list 105. At this point, it is finally possible to start analyzing each alarm's history, through the creation of the sliding windows. For this purpose, initially, it is created an array with the same length as the number of alarms to be analyzed, with each array entry representing an array with the same length as the list of all unique trios detected, initialized with zeros in every entry. Thereafter, for each alarm, the algorithm iterates through the native dataset counting how many times each trio has occurred and updates the value on the array of occurrences. At the end of this procedure, it achieves a matrix where the number of rows is equal to the number of alarms, the number of columns is equal to the number of unique trios, and each entry represents how many times a trio has occurred during the observation window of its alarm. This step is crucial to be efficient as it is the heaviest and will iterate multiple times through the dataset. If a naive approach would have been used for this step, the sliding windows algorithm complexity would be θ(N²); however, through the following optimizations, it was possible to lower it close to θ(N):
Chronological Order—as stated in step one, the entire native dataset was chronologically ordered, which helps to reduce the number of iterations through the dataset massively. Having this property means that during iteration through all the alarms, from the first detected (oldest) to the latest (newest), when the alarm that originated the sliding window process is detected, the process can stop as all the alarms forward will be more recent than the originator, so it can never have any degree of causality.
Saving Last Used Index—since the alarms are temporally organized, it is evident that an event that is not part of the observation window of a past alarm can never be part of one that occurred afterward (since if it already violated the maximum time deviation, the difference will be even more significant). Thus, by saving the index of the first alarm used in the past observation window, it is possible to know which was the first event to be part of the last observation window. So, instead of having to iterate from the first alarm to fill in the causality matrix, this process can start at the first input used in the last observation window. Thus, reducing the number of iterations significantly through the native dataset for each window.

After completing this step and concatenating all sliding windows, an intermediate matrix 106 is created. Even though the matrix itself is the final causality matrix, the target variable is yet to be set. As the matrixes for all unique problems within the same time frame are identical, except for the target column, this intermediate step saves numerous calculation iterations, minimizing not only the load on the system but also the execution time. Thus, at the end of the concatenation process, an array with the problem that originated each sliding window 107 is simultaneously created. So, for each ML model, to generate the target variable and create the final causality matrix which will be used as input, it is only necessary to perform a boolean comparison between the value stored in the target array and the model's specific problem. In system 108 it is observable the causality matrix that would be obtained to supply the ML model that detects correlations of the SP1 problem. However, despite all the efforts to create models that are as specific as possible, which allows them to be able to extract the most accurate and precise information, a vast aggregation is still made around the specific problem that occurred. Therefore, as can be seen in FIG. 1B, a more precise version was also developed and implemented, in which instead of creating a ML model for each unique problem, a ML model was created for each unique trio. Thus, a lot of entropy is removed from the models since the root cause of a certain malfunction may vary depending on the technology and manufacturer of the equipment under analysis. All pre-processing applied is identical to FIG. 1A apart from the values stored in the auxiliary array. After calculating all the sliding windows, the specific trio that was the originator of that window is then stored in the auxiliary array 109. Finally, the boolean comparison is applied to each model, where for the model responsible for the SP1-T1-T2 trio, the causality matrix 110 would be obtained.

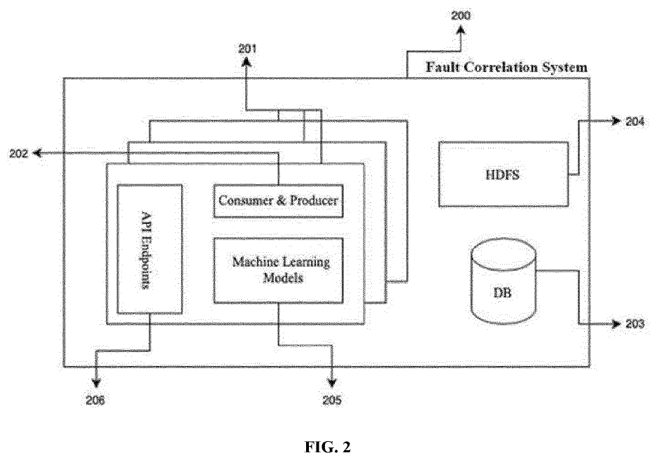

FIG. 2 is a diagram of the architecture of the entire framework developed in 200, representing all the components needed to be executed in cluster scenario 201. Since the alarms used for training and correlation detection are captured and propagated by the distributed TO stream platform, a component capable of consuming them is needed 202. This platform is message-oriented middleware (MOM) as it works through topics and partitions, so all the information about a topic will be divided homogeneously among all the partitions, guaranteeing better scaling and load balancing, and consumed by subscribers of the topic. This platform feature smooths the implementation of the tool on several instances as they all subscribe to the same topic responsible for propagating and identifying events on the network, and due to its multiple partitions, all instances have messages to consume in a balanced way. Additionally, any alarm consumed by one instance will never be seen by another since once it is consumed from the partition, it is removed and will not be seen by any other subscriber of the topic, thus ensuring that no repetitions are processed (which would have a detrimental effect on the causality detection task). Additionally, although there is already parallelism as multiple instances are running simultaneously, parallelism has been introduced on each instance as well. Thus, it has a pool of threads responsible for message consumption, ensuring that they will never affect the execution of the tool or create bottlenecks in the number of requests it is able to process. Once the alarm is consumed, if it has the necessary characteristics for storage (as not all of them are useful for the task at hand), it is stored persistently in an external database 203. Since several instances are running the tool in parallel 201, the database cannot be local to these, otherwise, each instance would return different responses to the same request. Thus, the database is running on an external instance, ensuring that all instances have access to the same information and work cooperatively.

Every time an alarm is added, the number of occurrences of the originating trio is incremented, and the training conditions are checked. When these are met, the same component responsible for alarm consumption will have an inverse responsibility: to be a producer 202. Thus, a second thread pool is available for this task, and whenever a trio has met the conditions for training, a message is produced, identifying the trio to train. This mechanism was used because, as with message consumption, a balancing service is provided. So, an instance can detect that a trio has reached the training conditions, and produce the training message, but for load balancing reasons, it will be trained on a different instance 201, thus ensuring a distributed operation without the need to elect a group leader (which implies an initial overheard and as well in case of its failure). Once the training message has been consumed, it is verified whether it is the first time the trio will be trained (creation of the ML model) or if it is an improvement of a previously trained ML model (increase in the number of predictors, thus accommodating new knowledge in the model). Afterward, all database alarms are read, initiating the process described in FIG. 1 that will lead to the creation/improvement of trained ML models 205. These need to be persistently saved as they will be used and evolved over time to extract the maximum amount of information from the system. However, because of the amount of data they process, they become reasonably large and cumbersome to continuously read/write to database. So, a new mechanism was used: they are stored on the instance's local disk and the path is saved in the database. However, as mentioned earlier, several instances are running in parallel, so it was necessary to implement a distributed file system (HDFS) 204. This allows all to have access to the same information, thus guaranteeing once again that no matter which instance answers a request, the answer will be identical. Finally, having already trained alarms, it is necessary to access them to extract the information they have detected to be able to perform their prediction task. So, an API 206 was developed with several endpoints capable of extracting and returning this information, providing the TO's admin is duly authenticated in the system.

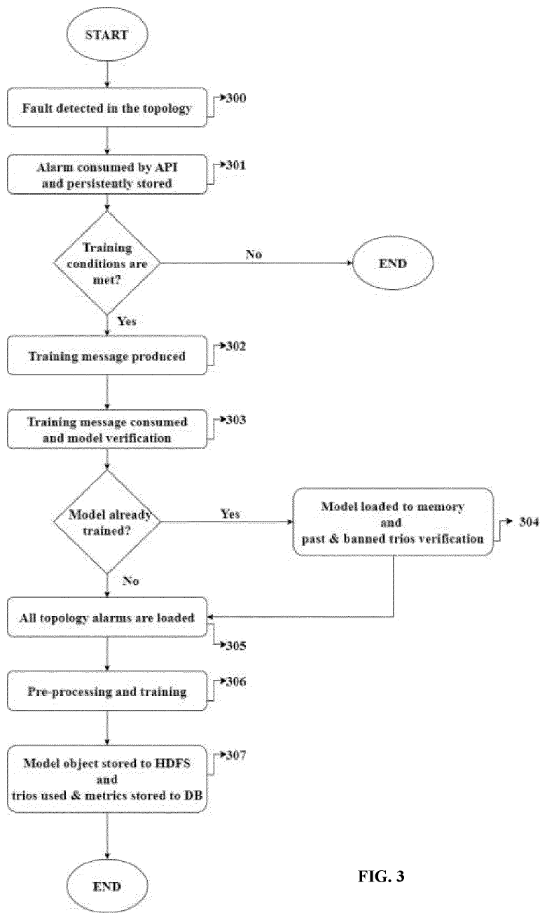

FIG. 3 is a flowchart that demonstrates the behavior of a topology alarm consumption and how it can trigger a training phase. As previously mentioned, the TO's topology is continuously operating, and whenever an equipment failure is detected, an alarm instance is generated and propagated by the TO's stream platform 300. When this message is propagated to the appropriate topic, it is immediately detected by the pool of API consumers, identifying if it is a relevant instance for processing, and is subsequently stored persistently 301, allowing it to be used for a subsequent training phase. After storage, if the number of occurrences of the generated alarm trio reaches the conditions required for training, the process is started. Thus, the message identifying which trio will be trained 302 is generated, and this message will be consumed by one of the instances in cluster 303, which immediately verifies whether it is the first training of a trio or an ML model refinement. If the model already exists, it will be loaded not only to perform the predictor augmentation and run a new training phase but also to identify which trios were used in the previous phase 304, as it cannot be changed without destroying the model. If it is the first time the trio is being trained, or if it exists and the past trios used and the banned ones have already been checked, all the alarm instances are loaded 305, allowing the application of the innovative preprocessing, thus generating the new dataset that will be used for training 306. After the model has been trained or improved, it is again saved permanently, along with the information about the trios used and the metrics that were obtained 307, until the conditions for the next training are met.

Regarding the API it was considered essential to implement an authentication mechanism, ensuring that access to the extrapolated topology information is private. Thus, a system administrator, before being able to access the multiple API endpoints provided, must authenticate himself, to receive the token he will need to provide, to get responses from the API. Within the API, there are four endpoints worth mentioning, as they are the ones responsible for interacting with the ML models, being able to introduce and extract all the information that they have developed during their training phase, thus identifying the desired topology correlations.

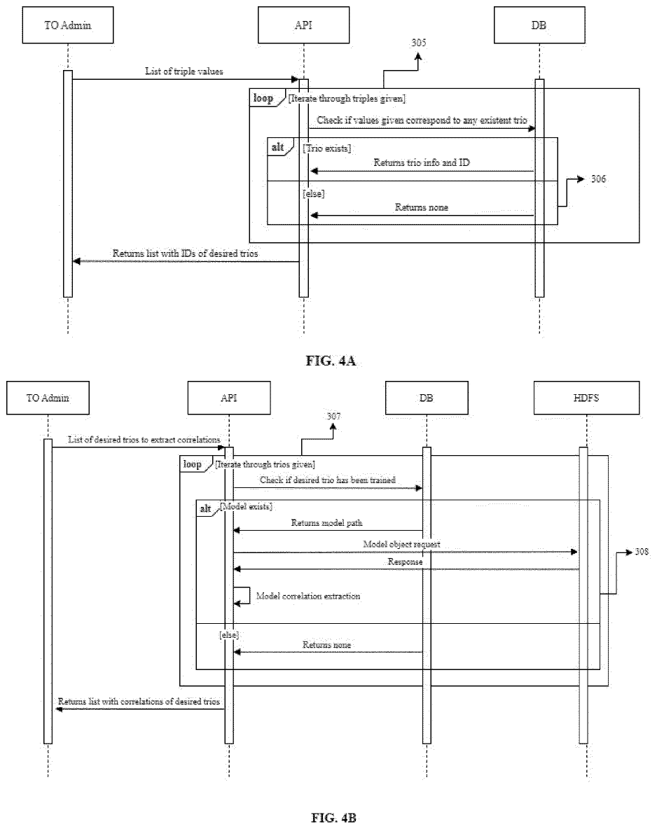

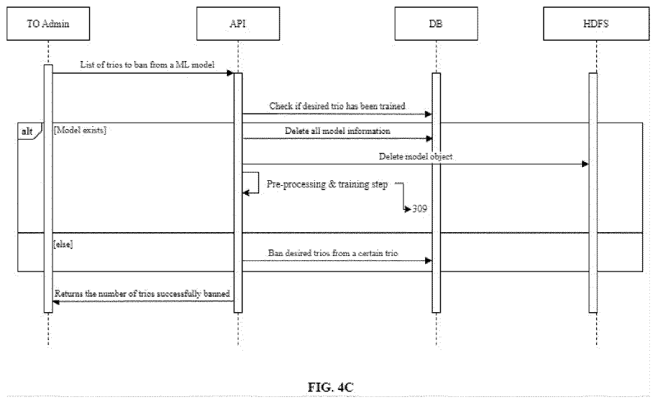

FIG. 4A is a sequence diagram that represents the process responsible for obtaining the IDs of trios through their respective values. Since each trio is unique per model—that is, only one model has the task of predicting, after analyzing the causality matrix, whether a certain trio occurs—it is the main entity of the entire system, and its ID value is used to execute the remaining endpoints. Thus, at an initial moment, a system administrator provides the values of one or more triples to check if they have already been identified in the system and if the remaining operations can be performed upon them. As the number of trios in the topology changes over time, the number of trios returned varies 406 between 0 (no trios of the requests have been identified in the topology yet) and the length of the list passed (all the requested trios have already been checked in the system).

FIG. 4B is a sequence diagram representing the process responsible for extracting the correlations detected by the ML models. In this way, a system administrator can request one or more trainings over which he desires to obtain the detected correlations. The system will iterate over the various trios 407, applying the same process to each: (i) determining whether the trio on which is desired to extract correlations has already been trained 408 (as topology knowledge extraction is only possible from a trained model); (ii) if it has been, the system receives its information, metrics obtained in training and the corresponding path to the object on disk; (iii) with this, the model is read from the shared disk partition (ensuring that the answer is identical, irrelevant of the instance to which the request was made) ; (iv) with the model loaded in memory it is possible to apply the process of extraction of detected correlations, which will be the endpoint's output. As the number of models trained changes over time, as they are only created when the training requirements are met, the output list can vary, like the previous endpoint, between 0 and the length of the input list.

FIG. 4C is a sequence diagram representing the process of banning trios as predictors of an ML model. Since no topology information is provided a priori to the models, the models rely solely on the predictors in the provided dataset to perform the prediction task. However, this can lead to Post Hoc, Ergo Propter Hoc scenarios in which causality is assigned to a trio that, despite frequently occurring prior to the one under analysis, does not correlate. Thus, at any moment, the administrator can indicate which trios should be ignored as predictors in the training of a certain model, thus removing them from its sample universe and consequently completely banning all correlation detection between them. In the scenario where the model exists and it is desired to deny a correlation, the model must be destroyed and retrained 409, since the number of predictors provided cannot be changed from the moment of its creation. In the scenario that a relationship wants to be banned, the model is deleted, and all predictors detected so far, except for the banned, will be used (thus also introducing previously ignored trios, as they were detected only after the ML model's creation).

1. A self-adaptive fault correlation system adapted for managing predicting abnormalities of a communications network comprising:
receiving real-time alarm anomaly data;
fetching all previous five-minute alarm data, processing said time-series data and generating a casualty time window;
detecting if received anomaly data has occurred in the past;
if this is the first occurrence of received anomaly, training a machine learning model for predicting an instance of said anomaly;
if it is not the first occurrence of received anomaly, refining the corresponding anomaly machine learning model;
storing the trained models;
identifying and exporting the inferred correlations between alarm anomaly data.

2. The system according to claim 1, wherein the pre-processing of the time-series alarm anomaly data compromise:
extracting relevant attributes from the anomaly data;
calculating all existing combinations of the attributes using the cartesian product;
storing generated data in a matrix where each row corresponds to each alarm instance sample and each column a predictor.

3. The system according to claim 1, wherein the attributes of the time-series anomaly data are the occurrences of the trios which comprise the specific problem the equipment manufacturer and the technology in use. 4. The system according to claim 1, wherein the machine learning algorithm is Random Forests.

5. The system according to claim 1, wherein the refinement of said anomaly machine learning model compromises a predictor augmentation and a new training phase.

6. The system according to claim 1, wherein the anomaly machine learning models are stored in a distributed file system.

7. The system according to claim 1, wherein the identification and export of the inferred correlations between alarm anomaly data is performed using an Application Programming Interface by an user or a computational processing device adapted for such.
